(19) United States
(12) Patent Application Publication
(10) Pub. No.: US 2005/0265318 A1
(43) Pub. Date: Dec. 1, 2005

(54) Apparatus, system, and method for rejecting a session establishment request

(75) Inventors: Hisham Khartabil, Oslo (NO); Kati Korolainen, Lempaala (FI)

Correspondence Address: Hollingsworth & Funk, LLC;Suite 125, 8009 34th Avenue South, Minneapolis, MN, 55425, US

(73) Assignee: Nokia Corporation

(21) Appl. No.: 11/125,534

(22) Filed: May 10, 2005

Related U.S. Application Data
(63) Continuation-in-part of application No. 10/755,205, filed on Jan. 8, 2004.

(51) Int. Cl. H04L 12/66

(52) U.S. Cl. 370/352

(57) ABSTRACT

Rejecting a session request initiated via a session establishment protocol involves receiving, at a first network terminal, a session initiation request sent from a second network terminal via the session establishment protocol. A rejection message of the session establishment protocol is formed based on a presence state of the first network terminal. The rejection message is sent via the session establishment protocol targeted for the second network terminal.

This is a continuation-in-part of U.S. patent application Ser. No. 10/755,205, entitled “Apparatus, System, And Method For Rejecting A Session Establishment Request,” filed on Jan. 8, 2004, the content of which is incorporated herein by reference in its entirety.

### FIELD OF THE INVENTION

This invention relates in general to data communications sessions, and more particularly to a method, system, and apparatus for rejecting session establishment requests.

### BACKGROUND OF THE INVENTION

Personal communication devices are becoming more widely adopted by the public. Such devices as cellular phones, personal digital assistants, and laptop computers give users a variety of mobile communications and computer networking capabilities. Digital connectivity is commonly available between mobile devices to provide users with many advanced communications services. These communications services may include voice, video, graphics, and many other forms of digital data that can be exchanged between users.

Although the flexibility of modem communications devices allows a rich variety of data to be transferred, some aspects of these communications may be little improved over simple telephone systems. This can be seen, for example, in situations where one user tries to contact another user for immediate communications. If the person being contacted is unavailable, digital communications systems typically provide the equivalent of an old fashioned busy signal—the person who initiated the communication is merely informed the other party is unavailable.

The rejection of an attempted communication can be frustrating in an urgent situation. The initiating party is forced to keep trying to connect without receiving any indication if or when the other party might answer. Further, since mobile communications devices may have multiple ways of communicating, the initiating party may not be aware that there is an alternate method of communicating that may provide a satisfactory response.

What is needed is to provide an improved manner of rejecting connection attempts. Such an improved manner of handling rejections should be highly adaptable and be capable of being integrated with a many data communication systems.

### SUMMARY OF THE INVENTION

A system, apparatus and method for rejecting a session establishment request is disclosed. The session establishment request is initiated via a session establishment protocol operable via a network. In one embodiment, a method involves receiving at a first network terminal a session initiation request sent from a second network terminal via the session establishment protocol. A rejection message of the session establishment protocol is formed based on a presence state of the first network terminal. The rejection message is sent via the session establishment protocol targeted for the second network terminal.

In more particular embodiments, the method may involve determining the presence state of the first network terminal based on a user selection. In one configuration, after receiving the session initiation request, a user of the first network terminal is prompted with an option to reject the session initiation request using the presence state of the first network terminal.

In other more particular embodiments, the session establishment protocol may include the Session Initiation Protocol (SIP). Forming the rejection message may involve including a reason descriptor based on the presence state in a reason phrase of a start line of a SIP header of the rejection message. Forming the rejection message may also involve including a reason descriptor based on the presence state in a Warning entry of a SIP header of the rejection message. The rejection message may also be formed with a reason descriptor based on the presence state in a SIP extension header of the rejection message. The rejection message may include at least one of a SIP “486” message, a SIP “600” message, and a SIP “603” message.

In another embodiment of the present invention, a data terminal includes a network interface configured to communicate via a network A memory stores a message module, and a processor is coupled to the network interface and the memory. The processor is operable by the message module to receive via the network interface a session establishment request of session establishment protocol; determine a presence state of the data terminal; form a rejection message of the session establishment protocol based on the presence state; and send the rejection message targeted for an originator of the session establishment request via the network interface.

In more particular embodiments, the data terminal may include a graphical user interface (GUI) coupled to the processor. The processor is operable by the message module a to detect, via the GUI, a user selection that determines the presence state of the data terminal. The processor may be operable by the message module to provide to a user, via the GUI, an option to reject the session initiation request using the presence state.

In another embodiment of the invention, a system includes a network providing communications via a session establishment protocol. A first terminal is capable of establishing multimedia data sessions via the network using the session establishment protocol. A second terminal includes a network interface capable of communicating via the network. A processor coupled to the network interface. The processor operable to: receive via the network interface a session establishment request from the first terminal; determine a presence state of the second terminal; form a rejection message of the session establishment protocol based on the presence state; and send the rejection message to the first terminal via the network interface. The first terminal is configured to receive the rejection message and display a reason descriptor text based on the rejection message to a user of the first terminal.

In another embodiment of the invention, a computer-readable medium is configured with instructions for causing a processor of a data processing arrangement to perform steps that include receiving via a network a session establishment request of a session establishment protocol; determining a presence state of the data processing arrangement; forming a rejection message of the session establishment protocol based on the presence state; and sending, via the network, the rejection message targeted for an originator of the session establishment request.

In another embodiment of the invention, a system includes: means for receiving at a first network terminal a session initiation request sent from a second network terminal via the session establishment protocol; means for forming a rejection message of the session establishment protocol based on a presence state of the first network terminal; and means for sending the rejection message via the session establishment protocol targeted for the second network terminal.

### BRIEF DESCRIPTION OF THE DRAWINGS

The invention is described in connection with the embodiments illustrated in the following diagrams.

FIG. 1 illustrates a system environment in which embodiments of the present invention may be employed;

FIG. 2 is a system diagram illustrating a session initiation arrangement according to embodiments of the present invention;

FIG. 3 is a sequence diagram showing a session initiation message exchange according to embodiments of the present invention;

FIG. 4 is a graphical user interface for setting rejection message templates according to embodiments of the present invention;

FIG. 5 is a graphical user interface for setting alternate rejection message templates according to embodiments of the present invention;

FIG. 6 is a graphical user interface for displaying reasons received in rejection messages according to embodiments of the present invention;

FIG. 7 is a graphical user interface for setting rejection message templates in a scheduling application according to embodiments of the present invention;

FIG. 7A is a graphical user interface for accessing presence functions used in conjunction with message templates according to embodiments of the present invention;

FIG. 7B is a graphical user interface for accessing presence functions used in conjunction with message templates according to embodiments of the present invention;

FIG. 8 illustrates a mobile terminal according to embodiments of the present invention; and

FIG. 9 is a flowchart showing a message rejection procedure according to embodiments of the present invention.

### DETAILED DESCRIPTION OF THE INVENTION

In the following description, reference is made to the accompanying drawings which form a part hereof, and in which is shown by way of illustration various embodiments in which the invention may be practiced. It is to be understood that other embodiments may be utilized, as structural and operational changes may be made without departing from the scope of the present disclosure.

Generally, the present disclosure relates to providing informative rejection messages in response to data communication session initiation attempts. The informative responses may be included in standard rejection responses of the protocol used to establish the sessions. This means that no separate message needs to be sent informing the caller of the rejection reason, thus saving round trip times and network traffic.

One protocol used in establishing data communication sessions has been defined by the Internet Engineering Task Force (IETF), and is known as the Session Initiation Protocol (SIP). SIP is a standard signaling protocol currently defined in IETF RFC 3261 that operates on the application layer of the Open Systems Interconnection (OSI) networking model. Although the use of informative rejection responses may be described herein in terms of SIP, it will be appreciated that these concepts can be applied to any manner of establishing data sessions known in the art.

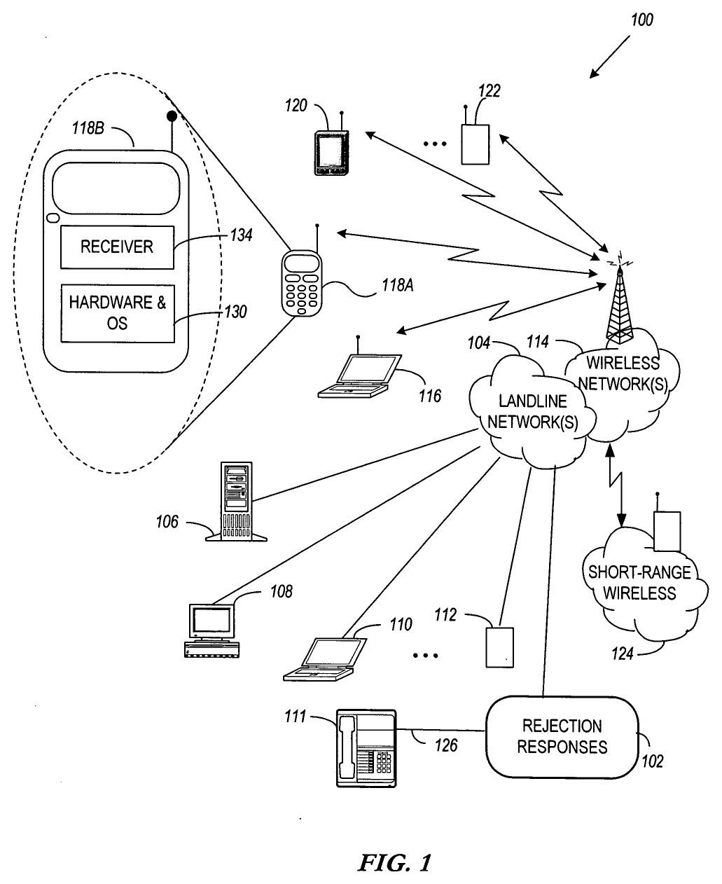

FIG. 1 illustrates a representative system environment 100 in which the principles of the present invention may be employed. In the representative system environment 100, rejection responses 102 may be communicated between target devices in any number of known manners. The rejection responses 102 are generally transmitted in response to a failed attempt to initiation communications between target devices. The manners of communicating the rejection responses 102 include via a landline network(s) 104, which may include a Global Area Network (GAN) such as the Internet, one or more Wide Area Networks (WAN), Local Area Networks (LAN), and the like. Any computing device or other electronic device that supports data sessions (e.g., soft-phone running on a computer) may be the target system that utilizes the rejection responses 102, including servers 106, desktop computers 108 or workstations, laptop or other portable computers 110, a SIP phone 111, or any other similar computing device capable of communicating via the network 104, as represented by generic device 112.

The rejection responses 102 may be provided via one or more wireless networks 114, such as Global System for Mobile Communications (GSM), Universal Mobile Telecommunications System (UMTS), Personal Communications Service (PCS), Time Division Multiple Access (TDMA), Code Division Multiple Access (CDMA), or other mobile network transmission technology. Again, any mobile electronic device that can be used to join in data sessions can utilize rejection responses 102, such as laptop or other portable computers 116, mobile phones 118A and other mobile communicators, Personal Digital Assistants (PDA) 120, or any other similar computing device capable of communicating via the wireless network 114, as represented by generic device 122.

The rejection responses 102 may be transferred between devices using short-range wireless technologies 124, such as Bluetooth, Wireless Local Area Network (WLAN), infrared (IR), etc. The rejection responses 102 can also be distributed using direct wired connections, such as depicted by connection path 126. The concepts described herein are applicable regardless of the manner in which rejection responses 102 are provided or distributed between the target devices.

An example of a target device that utilizes informative rejection responses 102 is illustrated as the mobile phone 118B. The device 118B includes, for example, a radio transceiver 134 and hardware (including the processor) coupled to an operating system (OS) 130. The functional components of the mobile phone 118B that communicate the rejection responses 102 may be implemented as firmware or as a program running on the OS 130.

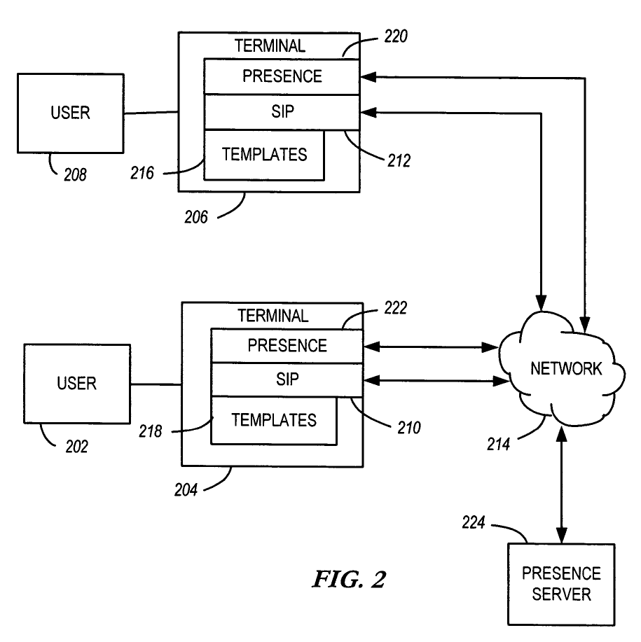

In reference now to FIG. 2, a system is illustrated according to embodiments of the present invention. A user 202 has a SIP enabled terminal 204. The SIP enabled terminal 204 may be used for any type of data session, including voice, video, text, document sharing/collaboration, teleconferencing, etc. In this example, the user 202 wishes to connect to the user 208 of a second terminal 206. The second terminal 206 is also SIP enabled, and it may be assumed that the second terminal 206 is capable of communicating with at least one type of session supported by the first terminal 204.

Generally, the terminals 204, 206 each include a SIP processing module or stack 210, 212, respectively. The SIP processing stacks 210, 212 are used for initiating data sessions over a network 214 by exchanging SIP messages. In SIP terminology, the terminals 204, 206 are referred to as User Agents (UA). According to the SIP protocol, a calling terminal 204 initiates a session by sending a message such as “INVITE” to the receiving terminal 206. There is a wide range of response messages that the calling terminal 204 may receive in response to the “INVITE” request. Initially, the calling terminal 204 may receive a “100” (Trying) message from a next-hop server. The calling terminal 204 may also receive messages from the receiving terminal 206, such as “180” (Ringing) and “200” (OK). If the receiving terminal 206 is able to receive an incoming connection, but the user 208 is unwilling or unable to take calls, the terminal 208 returns an error message to the calling terminal 204. This error message may be a “486” (Busy Here) message, although other messages may also be used, including “480” (Temporarily Unavailable), “600” (Busy Everywhere) and “603” (Decline) messages.

The SIP error messages returned to the calling terminal 204 gives a general indication that the receiving user 208 is unavailable, but these messages do not convey why the user is unavailable. A standard SIP implementation may include the text “486 Busy Here” in the start line of the response message. The “Busy Here” part of this text is known as the reason phrase, and “Busy Here” is the reason phrase suggested by the SIP standard for status code “486”. However, The SIP standard allows you to place any text in the reason phrase that follows the status codes (e.g. “486”, “606”, etc). So, instead of a SIP stack sending “486 Busy Here” to a call rejected by a user, the SIP stack can ask the user (or application on behalf of the user) to give a more accurate reason for rejecting the call. The SIP stack can then build the SIP error response using the rejection reason. That rejection reason can appear in place of the “Busy Here” reason phrase. The reason phrase can be built using user input, such as “I'm in a meeting”.

In the illustrated system, this functionality is provided by a template module 216 of the receiving terminal 206. The template module 216 allows the user 208 to define useful responses in rejection messages sent to the initiating terminal 204. These responses may be stored in the form of message templates. The message templates may be simple text strings used to place in predetermined portions of the rejection messages, or the message templates may include portions of a rejection messages with various values that are automatically filled in when the rejection is sent. Message templates corresponding to different responses can be selected by the user 208 depending on the conditions, and the responses can be custom-tailored for various callers. The initiating terminal 204 may also include a template module 218 that can be used to receive these responses and communicate the responses to the user 202.

The template modules 216, 218 may include session related functionality such as setting and checking of user availability status, and creating modified response messages for the SIP processing stacks 210, 212. The modules 216, 218 may provide APIs for interfacing availability functions to other terminal software. A Graphical User Interface (GUI) may be provided by the template modules for setting availability options and for selecting and displaying rejection messages.

The template modules 216, 218 may also interface with other communications protocols besides SIP, such as GSM. The SIP processing stacks 210, 212 and template modules 216, 218 may also interact with other terminal software components, such as presence modules 220, 222, respectively. The term “presence” generally refers to the availability and willingness of the user (or other entity) to engage in communications. The user or other entity is referred to as a “presentity” in the context of presence systems. Presence technology includes applications and services that facilitate location and identification of communication link endpoints associated with presentities. For example, if a user of a wireless, handheld device would like to initiate an instant messaging (IM) session with another IM user, presence services may be used to present users' availability and willingness to receive IM messages.

Various presence formats and mechanisms are known in the art. Proprietary protocols exist, such as AOL instant messaging (AIM). In response to the success of AIM and other protocols, a new collection of open formats and protocols for IM was developed by the Internet Engineering Task Force (IETF). These protocols include the IETF Common Profile for Instant Messaging (CPIM) and Common Profile for Presence (CPP), described in RFC 3863. The CPIM and CPP specifications describe a set of operations and parameters that may be used to achieve interoperability between different IM and presence protocols. The RFC 3863 also describes the Presence Information Data Format (PIDF), which is a common presence data format for CPP-compliant presence protocols.

It will be appreciated that the presence modules 220, 222 may be designed to interoperate with any combination of IM and presence systems and formats. Presence data utilized by network entities such as the terminals 204, 206 is typically stored a presence server 224 or similar entity accessible via the network 214. The presence modules 220, 222 may be configured to interoperate with a presence server 224, as well as allowing the users 202, 208 to locally maintain and control their presence data. The presence modules 220, 222 may also provide the users 202, 208 with the ability to determine presence data associated with other presentities (e.g., acting as a “watcher” application). The presence data exchanged via the network 214 may include such presence states as (e.g., “at home,” “busy”) that can describe the location and availability of the users 202, 208.

It will be appreciated that the presence data utilized by the presence modules 220, 222 may be coordinated with the message templates defined via the template modules 216, 218. In particular, the presence state may be used to form rejection messages sent via the SIP processing stacks 210, 212. For example, the presence data and message templates may be stored on the terminals 204, 206 using a common format. The presence data and message templates may be made simultaneously accessible to the presence modules 220, 222 for maintaining presence state and by the template modules 216, 218 for providing rejection messages via the SIP processing stacks 210, 212. In this way, the user does not need to maintain two separate states for each of IM/presence and call rejection. At any given time, the same state is most likely equally applicable to the user's availability using either communication means.

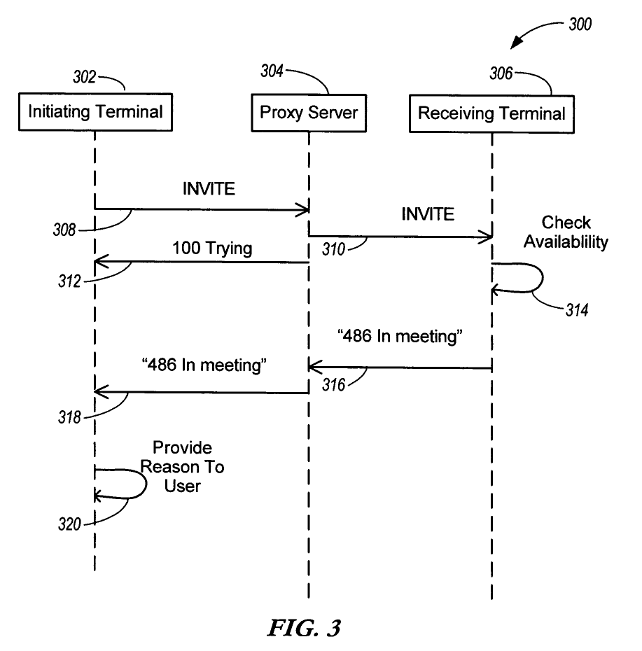

One example of a message exchange with an improved rejection message according to embodiments of the present invention is shown in the sequence diagram 300 of FIG. 3. The sequence begins with the sending of a SIP INVITE message 308 from an initiating terminal 302 targeted for a receiving terminal 306. An example of a SIP INVITE message 308 is shown in Listing 1. In this example, the terminals 302, 306 are connected via a proxy server 304. In many cases multiple network entities besides a proxy server may lie between the terminals, including gateways, routers, etc, although those have been left out the diagram 300 for clarity. Similarly, various SIP and network response messages (e.g., acknowledgements) may be omitted from the sequence diagram 300 for reasons of clarity.
INVITE sip:callee@terminal.example.com SIP/2.0
Via: SIP/UDP/2.0 proxy.com
From: sip:caller@example.com;tag=123

To: sip:callee@example.com

Call-id: abcd

CSeq: 1 INVITE

Max-Forwards: 69

Content-type: application/sdp

Content-length: . . .
[SDP Body]

### Listing 1

The SIP INVITE message 308 is received at the proxy server 304, which forwards the INVITE message 310 to the receiving terminal 306. The proxy server 304 responds to the initiating terminal 302 with a “100 Trying” message 312. Upon receiving the forwarded invite message 310, the receiving terminal 306 checks user availability 314. The checking of availability 314 may occur using an application-level software module such as the templates module 218 shown in FIG. 2. The templates module may maintain a previously set state of user availability and/or dynamically prompt the user in order to check availability 314.

Assuming that the receiving terminal 306 checks availability 314 and determines the session attempt should be rejected, the receiving terminal 306 then chooses an appropriate response message based on a user defined template. The choice of availability and/or the correct message template may involve many factors, including the current time, the identity of the initiating terminal 302, the session type requested, the configuration of the receiving terminal 306 (e.g., may require a special device attachment to engage in certain session types), the location of the receiving terminal 306, etc.

The availability may be determined 314 automatically, or the user may be prompted to decide the appropriate response. In situations where the receiving terminal 306 dynamically prompts the user to accept or reject the session, the user may select from a set of predetermined reason descriptors or type in a unique reason for rejecting the call. Those predetermined reasons may include any presence data stored on the terminal 306, including the current presence state.

In the present example, it is assumed the check of availability 314 results in the INVITE 310 being rejected because the user is unavailable. The receiving terminal 306 forms a rejection message 316 (e.g., status code “486”) that includes a reason descriptor explaining why the user of the receiving terminal 306 is unavailable. Two example “486” messages 316 that include a reason descriptor are shown in Listings 2 and 3. In Listing 2, the reason descriptor text “In a Meeting” is included on the start line of the SIP response message as a reason phrase, and in Listing 3 the descriptor is included in a “Warning” field of the SIP header (last line of Listing 3). The reason descriptor may also be included in other parts of the SIP message, such as in a SIP extension header.
SIP/2.0 486 In a Meeting
Via: SIP/UDP/2.0 proxy.com
From: sip:caller@example.com;tag=123
To: sip:callee@example.com;tag=456
Call-id: abcd
CSeq: 1 INVITE
Retry-After: 300

### Listing 2

SIP/2.0 486 Busy
Via: SIP/UDP/2.0 proxy.com
From: sip:caller@example.com;tag=123
To: sip:callee@example.com;tag=456
Call-id: abcd
CSeq: 1 INVITE
Warning: 399 terminal.example.com “In a Meeting”
Retry-After: 300

### Listing 3

In reference again to FIG. 3, the “486” message 316 is sent from the receiving terminal 306 targeted for the initiating terminal 302 via the proxy server 304. The proxy server 304 sends a forwarded “486” message 318 to the initiating terminal 302, which informs 320 the user of the reason included in the “486” message 318.

The message exchanges illustrated in FIG. 3 are only examples of message communications that provide a reason for a rejected message. In general, the response message is formed at the terminal (UA) rejecting the session request, and can thus be implemented without require additional message exchanges of the session establishment protocol. By using a session protocol message originating at the terminal 306, reason descriptors can be provided in the rejection messages without the interaction of intermediary network elements (e.g., proxies) or by using additional protocols (e.g., SMS).

Of course, in order for a terminal to reject connection attempts with an appropriate reason, the user may be required to interact with software to supply the reason descriptors for use in message templates. The message templates can be used for automatically generating rejection messages under various circumstances. The user may also want to select various times that the system is unavailable. In simple terminals, the reasons can be selected using a numerical keypad from a list of predetermined reasons, and numerical times can be entered directly. Since many mobile communications devices are capable of supporting a graphical user interface (GUI), a mobile terminal incorporating rejection responses as described herein may also include a GUI for controlling those responses. Similarly, the user receiving the rejection reason may include a text or graphical interface that informs the user of the reasons connection attempts were rejected. The user receiving the rejection may also want to have options for automatically dealing with certain rejections.

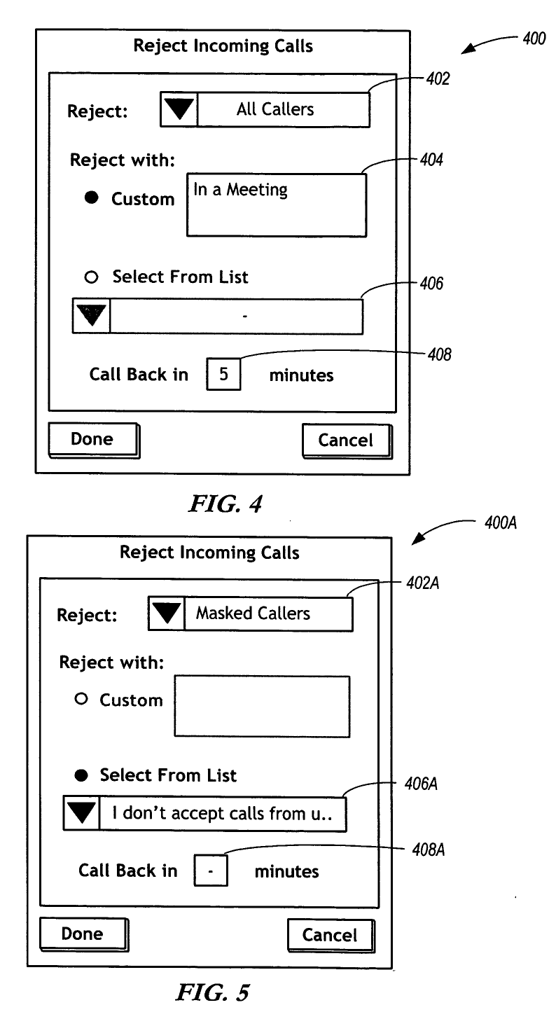

In reference now to FIG. 4, a GUI 400 is illustrated for setting call rejection reasons according to embodiments of the present invention. The GUI 400 is used to form one or more rejection message templates, and provides the user with pre-configurable statements of reasons for rejecting an incoming call or session request. As shown, this GUI 400 is configured to create a template for rejecting all callers during a certain time period. Typically, the GUI 400 would appear in response to the user selecting a menu option such as “Show As Busy.” The option to show the user as busy may be selected for only certain types of data (e.g., voice only) or may be related to all types of data receivable by the terminal.

The message template created by the GUI 400 can be used for automatically forming appropriate rejection messages (e.g., “486”) that include reasons why the sessions are being rejected. The message template may be created by the GUI 400 for a single event, or it may be may set up for a recurring event. For example, the GUI 400 may allow rejection of all calls from 11 PM to 6 AM with the reason “I am sleeping.” This template could be set to be active every night at the indicated time, or only on certain nights (e.g., weekends). When used to form an actual rejection message, the template may have certain data automatically filled in, such as a time to re-initiate the connection attempt. The time may be calculated based on the template parameters and the current time.

The GUI 400 includes various graphical components that control which connections are rejected and control the data placed in rejection messages. A drop-down list 402 allows selection of various types of connection types that will be rejected. In this example, the drop-down list 402 includes various user or terminal attributes that may be used to reject connection attempts. The attributes of rejected callers selected from the list 402 may include all callers (as shown), masked or anonymous callers, callers not in a specific group (e.g., the user's address book), known undesirable callers, callers from certain domains, etc. Other attributes for which a user may want to reject a call may also be included in the drop down list 402, such as session data types (e.g., voice, video) and cost-related attributes (e.g., calls carrying long distance and/or roaming charges).

The reason descriptor used in rejection messages may be drafted by the user in reason text field 404. The text field 404 allows the user to draft a custom reason descriptor used in all messages created by this template. For example, if the user desires to block only certain types of data sessions, the reason descriptor may recommend an alternate means of communication. So, if the user is in a meeting, attempted voice communications can be rejected with a reason that suggests contacting via email or Short Message Service (SMS). For convenience, the GUI 400 may also provide a drop-down list 406 of prepared reasons that the user may select instead of or in addition to the custom reason entered in the text field 404.

Since the user may want to reject connections for limited periods of time, the user may also enter a value into a time field 408 for informing an incoming caller when the user will be available. The value entered into the time field 408 could be appended to the reason text, as well as included in certain message fields, such as a SIP “Retry-After” header field. The system implementing a time field 408 input could keep an internal timer to automatically adjust the time value placed in any messages. The time value used in the message would be adjusted based on the value of the time field 408, the creation time of the template (assuming a relative time field value is used), and the time of the incoming connection request. The time field 408 may be implemented to accept a relative time (as shown) or an absolute time, such as “1:00 PM.” The time field 408 may also serve other purposes besides forming rejection message data. For example, a system implementing a time-based template for rejecting connections can automatically expire or delete the template based on the values placed in the time field 408.

Although a simple implementation of rejection message templates may include setting a single active template on a device, it will be appreciated that there may be situations where users have multiple reasons for rejecting incoming connections. For example, the user may wish to block certain callers all of the time, while at the same time blocking all callers for a finite time period only. As shown in FIG. 5, a GUI configuration 400A is shown that can be used for building additional or different rejection message templates according to embodiments of the present invention.

The GUI 400A in FIG. 5 may be accessed in essentially the same way as GUI 400 in FIG. 4, or may be reached via a different menu option. In this GUI 400A, the drop-down list 402A is set to only reject callers with masked or anonymous identities. Instead of a custom message, the rejection reason is selected from the drop down list 406A, which includes entries such as “I don't accept calls from unknown callers.” Since the rejection message template associated with this GUI 400A should be active at all times, the time field 408A is set to a null value.

The GUIs 400, 400A are configured to operate on devices that receive connection requests. Of course, it will be appreciated that the software that handles rejection messages and provides GUIs 400, 400A may also handle rejection messages sent from other callers in response to session attempts originating from this terminal. In such a case, the software may present a rejection message GUI 600 according to embodiments of the present invention for displaying these rejection messages.

The GUI 600 includes a text field 602 for displaying the reason for rejection. In addition, if the rejecting party has activated a callback time, this is displayed in the reason field 602 or in a separate call back time field 604. The device receiving the rejection message may be able to determine the callback time by parsing the reason field 602 text and/or from message headers. This time data is useful in informing the user when to call back, and the time data can also be used to automatically set a reminder for the user to call back. This can be done by the use of a callback reminder component 606. The user simply activates the callback reminder component 606, and a timer is set to remind the user to attempt the call again. The timed reminder could automatically ready the device with the user's identifier (e.g., phone number or Uniform Resource Identifier) for a simple, one-touch, connection re-attempt.

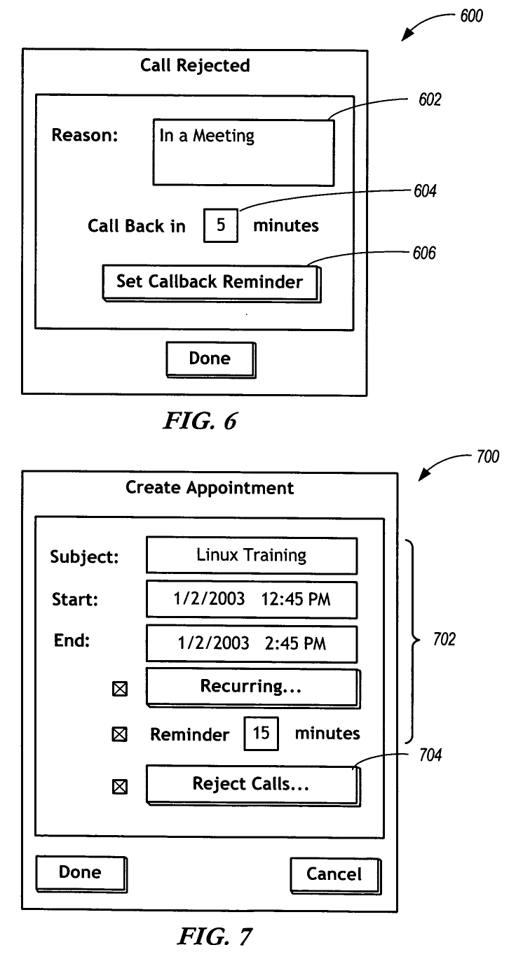

The GUIs in FIGS. 4-6 may be provided as standalone software, middleware, a system-level service, or be incorporated into an operating system. Because the rejection messages may apply to many types of communications (e.g., SIP, GSM, CDMA, SMS) it may be beneficial to supply a generic API for binding the rejection template functionality to various methods of data communications. Similarly, it may be desirable to provide access to the higher-level functions of the rejection message templates. For example, the GUIs and/or methods invoked by the GUIs may be accessible by system configuration software (e.g., an operating system control panel) or by user application software.

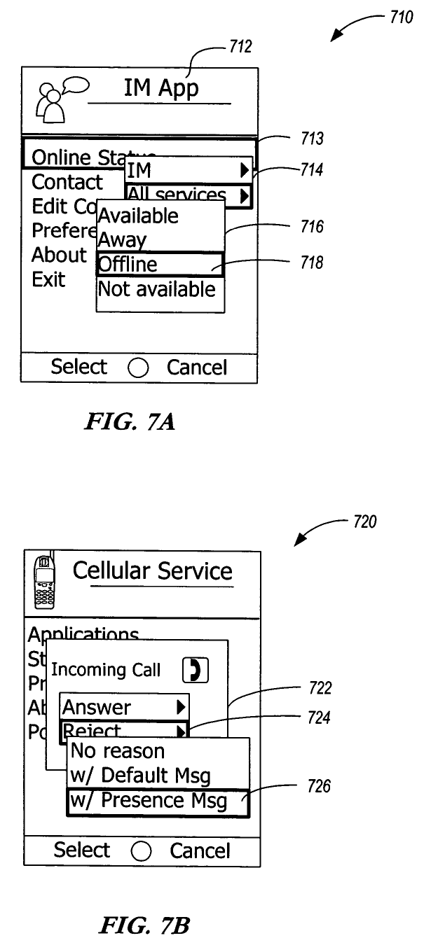

The functionality shown in connection with the GUIs in FIGS. 4-6 may also be made accessible by other application software. FIG. 7 illustrates an example application GUI 700 that may integrate call rejection functionality according to embodiments of the present invention. The GUI 700 represents an example configuration window for a Personal Information Manager (PIM) application. In particular, the GUI 700 is used to schedule an appointment in the PIM software. Users commonly utilize PIM software for scheduling and planning, and to receive reminders of such scheduled events. Appointments created using PIM software can be integrated with other functionality, such as sending out emails to schedule meetings. The emails are formatted based on the appointment parameters, and receivers of the emails can have the appointments automatically added to their own PIM schedule.

The GUI 700 includes appointment controls 702 that are typical of PIM applications known in the art. In addition, a call rejection component 704 can be integrated with the appointment controls 702 to provide automatic rejection of incoming messages based on parameters of the appointment. In this example, the call rejection component 704 is a push button that, when activated, brings up another GUI (e.g., GUI 400) that allows additional call rejection parameters to be set for a message rejection template. Because the rejection message template will be tied to an appointment created by the GUI 700, the rejection message template can be automatically configured, deleted, and/or modified based on actions that affect the appointment. For example, the rejection message template can be automatically configured with the start and stop times of the appointment. Any time changes made to the appointment will also be applied to the associated rejection message template.

In reference now to FIG. 7A, an example presence GUI 710 is presented that may be used in conjunction with message template functions according to embodiments of the present invention. The presence GUI 710 generally provides a way for the user to configure presence applications options as well as set the current presence state. As indicated in the title portion 712 of the GUI 710, the presence functionality may be associated an instant messaging application. It will be appreciated that presence may also be associated with other functions and applications of a mobile device, including paging, voice, text messaging, multimedia messaging, or any other mobile communications function now known or later developed. The presence functionality may be provided by each individual application, or may be built into the devices operating environment as a service or operating system function.

The GUI 710 provides a menu option 714 that allows setting the current presence state. As seen in the submenu 716, the presence state may be set for the IM application or for the system as a whole. Another submenu 718 includes the current presence states that the user may select. The presence states shown in the submenu 718 may be fixed in the system, or may be added on to by the user. It will be appreciated that the actual information communicated to other users via a presence server may a combination of the selections shown in the submenu 718 and other common indicators of state. For example, the selections for “Away” and “Offline” may both be textual representations that are accompanied by the same, standard value that used by a presence server to show that the user is unavailable.

In reference now to FIG. 7B, a GUI 720 illustrates the use of presence messages in dealing with incoming calls. In the scenarios illustrated in FIG. 7B, the user may have just entered an important meeting and is not able to answer phone calls. Just before the meeting started, the user changed his or her presence information as busy (e.g., by using a GUI 710 as shown in FIG. 7A). In the middle of meeting, the user notices that someone is trying to call, as indicated by the dialog 722. The user can't answer, but wants to tell the caller that he or she is in the middle of important meeting. The user may select the reject option 724 from the dialog 722 and uses a rejection reason as a “soft” reject. The user may manually or automatically send the user's presence information to the caller, as indicated by the selection 726 from the rejection submenu. This way, there is no need to build a separate message, such as by using a template as described above.

The communication capabilities as described herein are useful for any manner of communications device. In particular, mobile device can benefit from using descriptive rejection messages. Since users may carry and use these devices anywhere, the devices provide continuous and immediate access. This level of access is both a benefit and a nuisance. It is a benefit when a person can be immediately informed of an important event, but it is a nuisance to be interrupted during an important activity by a casual phone call. Providing the calling party a rejection message that includes a reason and an alternate time or method provides the best of both worlds. The mobile device user can gain a reprieve from interruptions, confident that any important communications can be re-attempted as soon as the user is ready to receive them. The contacting party is relieved from the frustrating uncertainty of a standard busy message when trying to effectuate vital communications.

Mobile devices are typically wireless device, such as wireless/cellular telephones, personal digital assistants (PDAs), or other wireless handsets, as well as portable computing devices capable of wireless communication. Of course, many of these devices are capable of wired/landline communications as well. These landline and mobile devices utilize computing circuitry and software to control and manage the conventional device activity as well as the multimedia session functionality as described herein. Hardware, firmware, software or a combination thereof may be used to perform the various session descriptor functions described herein.

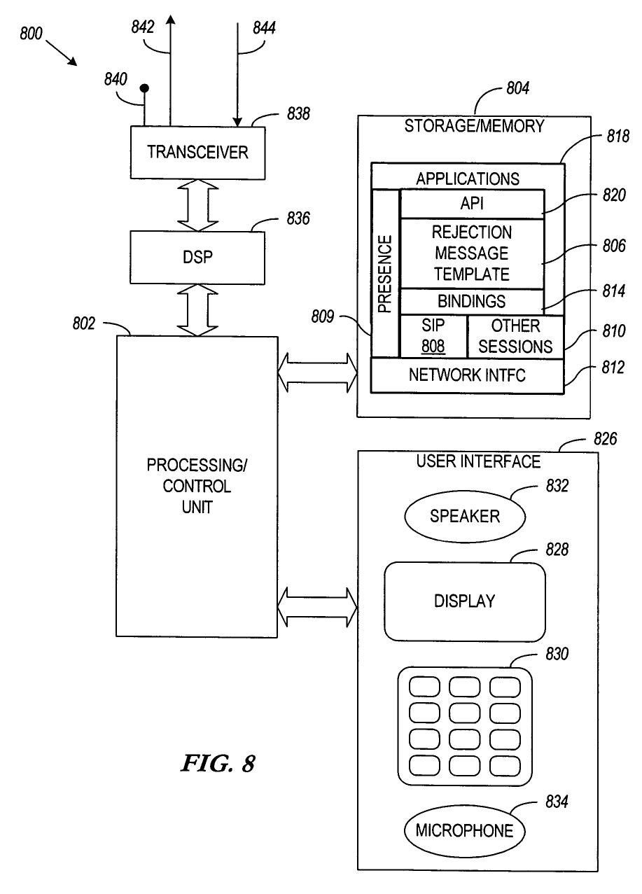

An example of a representative mobile terminal computing system capable of carrying out operations in accordance with the invention is illustrated in FIG. 8. Those skilled in the art will appreciate that the exemplary mobile computing environment 800 is merely representative of general functions that may be associated with such mobile devices, and also that landline computing systems similarly include computing circuitry to perform such operations.

The mobile computing arrangement 800 is suitable for processing data sessions in accordance with embodiments of the present invention. The representative mobile computing arrangement 800 includes a processing/control unit 802, such as a microprocessor, reduced instruction set computer (RISC), or other central processing module. The processing unit 802 need not be a single device, and may include one or more processors. For example, the processing unit may include a master processor and associated slave processors coupled to communicate with the master processor.

The processing unit 802 controls the basic functions of the mobile terminal. Those functions associated with rejecting session establishment messages may be included as instructions stored in a program storage/memory 804. In one arrangement, a rejection message template module 806 is included in the program storage/memory 804. The message template module 806 is operable to determine whether an incoming session request should be rejected and to select a reason descriptor to include with a rejection message.

The message template module 806 may communicate with a SIP processing module 808 for handling rejections for session requests received via SIP. The message template module 806 may also communicate with other session establishment protocols, as indicated by the other session module 810. Both the SIP module 808 and other session module 810 may communicate over one or more network interfaces 812.

The SIP processing module 808 may also interface with a presence module 809. The presence module 809 may include an interface for accessing current presence state(s) defined for the mobile terminal 800. The SIP processing module 808 may be enabled to manually or automatically retrieve presence data from the presence module 809 when forming SIP rejection messages. This presence data can be used to provide more informative rejection messages.

A binding interface 814 may be used between the message template module 806 and the session protocol modules 808, 810. The binding interface 814 may allow the message template module 806 to operate the same regardless of the underlying session and network protocols. The functions of the message template module 806 may be accessed by the user via a GUI of the module 806. In other arrangements, the functions of the message template module 806 may be accessed via other system applications 818. The message template module 806 may include an API 820 for providing this functionality to other modules or applications 818.

The program storage/memory 804 may also include an operating system and program modules for carrying out functions and applications on the mobile terminal. For example, the program storage 804 may include one or more of read-only memory (ROM), flash ROM, programmable and/or erasable ROM, random access memory (RAM), subscriber interface module (SIM), wireless interface module (WIM), smart card, or other removable memory device, etc.

In one embodiment of the invention, the program modules associated with the storage/memory 804 are stored in non-volatile electrically-erasable, programmable ROM (EEPROM), flash ROM, etc. so that the information is not lost upon power down of the mobile terminal. The relevant software for carrying out conventional mobile terminal operations and operations in accordance with the present invention may also be transmitted to the mobile computing arrangement 800 via data signals, such as being downloaded electronically via one or more networks, such as the Internet and an intermediate wireless network(s).

The processor 802 is also coupled to user-interface 826 elements associated with the mobile terminal. The user-interface 826 of the mobile terminal may include, for example, a display 828 such as a liquid crystal display, a keypad 830, speaker 832, and microphone 834. These and other user-interface components are coupled to the processor 802 as is known in the art. Other user-interface mechanisms may be employed, such as voice commands, switches, touch pad/screen, graphical user interface using a pointing device, trackball, joystick, or any other user interface mechanism.

The mobile computing arrangement 800 also includes conventional circuitry for performing wireless transmissions. A digital signal processor (DSP) 836 may be employed to perform a variety of functions, including analog-to-digital (A/D) conversion, digital-to-analog (D/A) conversion, speech coding/decoding, encryption/decryption, error detection and correction, bit stream translation, filtering, etc. The transceiver 838, generally coupled to an antenna 840, transmits the outgoing radio signals 842 and receives the incoming radio signals 844 associated with the wireless device.

The mobile computing arrangement 800 of FIG. 8 is provided as a representative example of a computing environment in which the principles of the present invention may be applied. From the description provided herein, those skilled in the art will appreciate that the present invention is equally applicable in a variety of other currently known and future mobile and landline computing environments. For example, desktop computing devices similarly include a processor, memory, a user interface, and data communication circuitry. Thus, the present invention is applicable in any known computing structure where data may be communicated via a network.

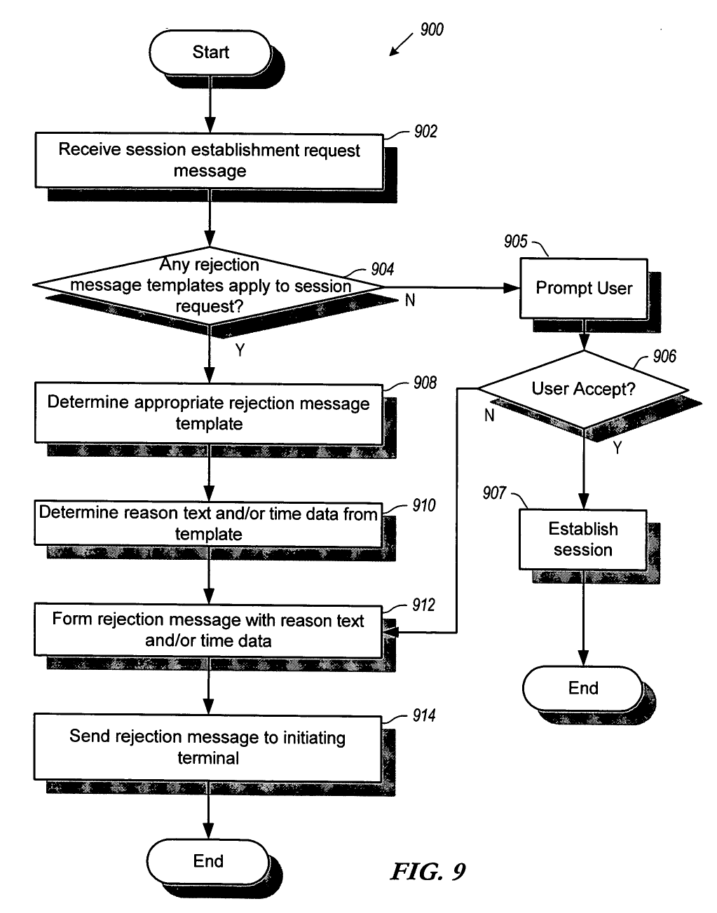

Referring now to FIG. 9, a procedure 900 is illustrated that may be used to provide session rejection messages in accordance with embodiments of the present invention. The procedure 900 begins when a session establishment request message is received (902) at a data terminal. The data terminal may include one or more rejection message templates that define whether to reject a particular session request message and a reason descriptor for the rejection. The templates may include message templates based on presence data. The data terminal checks (904) these rejection message templates to first determine whether the session establishment request should be accepted. If no rejection message templates apply, then the user is prompted (905) on whether to establish the session. If the user accepts (906) the session, then the session may be established (907) using the normal procedures of the session establishment protocol. If the user does not accept (906) the session, then the system may process the rejection message as described further below.

If at least one rejection template message applies, then the terminal may need to determine (908) the appropriate message template from one or more applicable templates. For example, the terminal may have a permanent rejection message template for masked callers and a time based rejection template active for an ongoing meeting. The correct rejection message may depend, in this example, primarily on the identity of the caller. Therefore, if the caller's ID is masked, the rejection reason relating to masked callers may be chosen. However, if the caller's ID is not masked, then the time based rejection message template may be chosen. In another example, the terminal may determine (908) a appropriate message template based on a presence state of the terminal. Terminal software may query a presence module to determine a presence state that is either automatically determined or set by the user.

In some configurations, it may be desirable to combine multiple rejection message templates into a single rejection message. For example, it would only waste time for a caller having a masked ID to re-initiate a session without masking his or her ID only to find the user is in a meeting. In either case, once the appropriate rejection message template(s) is/are chosen (908), the text describing the reasons and other data (e.g., time data) may be determined (910) from the template. This data can be used to form (912) the rejection message. Also, if the user has manually rejected (906) the message, then a reason descriptor text provided by the user can be used to form (912) the rejection message. The message is then sent (914) to the initiating terminal in accordance with the session establishment protocol.

Using the description provided herein, the invention may be implemented as a machine, process, or article of manufacture by using standard programming and/or engineering techniques to produce programming software, firmware, hardware or any combination thereof. Any resulting program(s), having computer-readable program code, may be embodied on one or more computer-usable media, such as disks, optical disks, removable memory devices, semiconductor memories such as RAM, ROM, PROMS, etc.

Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art are readily able to combine software created as described with appropriate general purpose or special purpose computer hardware to create a messaging system and method in accordance with the present invention.

The foregoing description of the exemplary embodiment of the invention has been presented for the purposes of illustration and description. It is not intended to be exhaustive or to limit the invention to the precise form disclosed. Many modifications and variations are possible in light of the above teaching. Thus, it is intended that the scope of the invention be limited not with this detailed description, but rather determined from the claims appended hereto.

1. A method for rejecting a session request initiated via a session establishment protocol operable via a network, comprising:
receiving at a first network terminal a session initiation request sent from a second network terminal via the session establishment protocol;
forming a rejection message of the session establishment protocol based on a presence state of the first network terminal; and
sending the rejection message via the session establishment protocol targeted for the second network terminal.

2. The method as in claim 1, further comprising determining the presence state of the first network terminal based on a user selection.

3. The method as in claim 1, further comprising, after receiving the session initiation request, prompting a user of the first network terminal with an option to reject the session initiation request using the presence state of the first network terminal.

4. The method as in claim 1, wherein the session establishment protocol comprises a Session Initiation Protocol (SIP).

5. The method as in claim 4, wherein forming the rejection message comprises including a reason descriptor based on the presence state in a reason phrase of a start line of a SIP header of the rejection message.

6. The method as in claim 4, wherein forming the rejection message comprises including a reason descriptor based on the presence state in a Warning entry of a SIP header of the rejection message.

7. The method as in claim 4, wherein forming the rejection message comprises including a reason descriptor based on the presence state in a SIP extension header of the rejection message.

8. The method as in claim 4, wherein forming the rejection message comprises forming the rejection message as at least one of a SIP “486” message, a SIP “600” message, and a SIP “603” message.

9. A data terminal comprising:
a network interface configured to communicate via a network;
a memory storing a message module; and
a processor coupled to the network interface and the memory, the processor operable by the message module to,
receive via the network interface a session establishment request of session establishment protocol;
determine a presence state of the data terminal;
form a rejection message of the session establishment protocol based on the presence state; and
send the rejection message targeted for an originator of the session establishment request via the network interface.

10. The data terminal as in claim 9, further comprising a graphical user interface (GUI) coupled to the processor, and wherein the processor is operable by the message module a to detect, via the GUI, a user selection that determines the presence state of the data terminal.

11. The data terminal as in claim 9, further comprising a graphical user interface (GUI) coupled to the processor, and wherein the processor is operable by the message module to provide to a user, via the GUI, an option to reject the session initiation request using the presence state.

12. The data terminal as in claim 9, wherein the session establishment protocol comprises a Session Initiation Protocol (SIP).

13. The data terminal as in claim 9, wherein the rejection message comprises a reason descriptor text based on the presence state.

14. The data terminal as in claim 13, wherein the reason descriptor text is placed in a reason phrase of a start line of a SIP header of the rejection message.

15. The data terminal as in claim 13, wherein the reason descriptor text is placed in a Warning entry of a SIP header of the rejection message.

16. The data terminal as in claim 13, wherein the reason descriptor text is placed in a SIP extension header of the rejection message.

17. A system comprising:
a network providing communications via a session establishment protocol;
a first terminal capable of establishing multimedia data sessions via the network using the session establishment protocol; and
a second terminal comprising,
a network interface capable of communicating via the network;
a processor coupled to the network interface, the processor operable to,
receive via the network interface a session establishment request from the first terminal;
determine a presence state of the second terminal;
form a rejection message of the session establishment protocol based on the presence state; and
send the rejection message to the first terminal via the network interface; and
wherein the first terminal is configured to receive the rejection message and display a reason descriptor text based on the rejection message to a user of the first terminal.

18. The system as in claim 17, wherein the second terminal further comprises a graphical user interface (GUI) coupled to the processor, and wherein the processor is operable by the message module a to detect, via the GUI, a user selection that determines the presence state of the second terminal.

19. The system as in claim 17, wherein the second terminal further comprises a graphical user interface (GUI) coupled to the processor, and wherein the processor is operable by the message module to provide to a user of the first terminal, via the GUI, an option to reject the session initiation request using the presence state.

20. The system as in claim 17, wherein the reason descriptor text is placed in a reason phrase of a start line of a SIP header of the rejection message.

21. The system as in claim 17, wherein the reason descriptor text is placed in a Warning entry of a SIP header of the rejection message.

22. The system as in claim 17, wherein the reason descriptor text is placed in a SIP extension header of the rejection message.

23. A computer-readable medium configured with instructions for causing a processor of a data processing arrangement to perform steps comprising:
receiving via a network a session establishment request of a session establishment protocol;
determining a presence state of the data processing arrangement;
forming a rejection message of the session establishment protocol based on the presence state; and
sending, via the network, the rejection message targeted for an originator of the session establishment request.

24. The computer-readable medium as in claim 23, wherein the steps further comprise detecting a user selection that determines the presence state of the data terminal.

25. The computer-readable medium as in claim 23, wherein the steps further comprise providing to a user an option to reject the session initiation request using the presence state.

26. The computer-readable medium as in claim 23, wherein forming the rejection message comprises including a reason descriptor based on the presence state in a reason phrase of a start line of a SIP header of the rejection message.

27. The computer-readable medium as in claim 23, wherein forming the rejection message comprises including a reason descriptor based on the presence state in a Warning entry of a SIP header of the rejection message.

28. The computer-readable medium as in claim 23, wherein forming the rejection message comprises including a reason descriptor based on the presence state in a SIP extension header of the rejection message.

29. A system comprising:
means for receiving at a first network terminal a session initiation request sent from a second network terminal via the session establishment protocol;
means for forming a rejection message of the session establishment protocol based on a presence state of the first network terminal; and
means for sending the rejection message via the session establishment protocol targeted for the second network terminal.
